(19) United States
(12) Patent Application Publication
(10) Pub. No.: US 2023/0315678 A1
(43) Pub. Date: Oct. 5, 2023

(54) STORAGE DRIVER FOR MANAGING A MULTIPLE LAYER FILE SYSTEM ON THE CLOUD

(71) Applicant: International Business Machines Corporation, Armonk, NY (US)

(72) Inventors: Jin Chi He, Xian (CN); Guang Han Sui, Beijing (CN); Gang Pu, ShannXi (CN); Dong Yu, Xi'an (CN)

(21) Appl. No.: 17/656,882

(22) Filed: Mar. 29, 2022

(51) Int. Cl. G06F 16/11; G06F 16/182

(52) U.S. Cl. CPC G06F 16/122; G06F 16/1824

(57) ABSTRACT

Creating a storage driver that is structured and configured to organize and operate a multiple layer file system on a cloud-based computing server, and more particularly to a containerized computing server. Additionally, the storage driver is used to improve the security of the containers and to define a static configuration of the multiple layer file system that is stored within the containers.

### BACKGROUND

The present invention relates generally to the field of cloud computing, and more particularly to practical and efficient storage related solutions for file systems that are utilized by cloud computing related hardware and/or software.

The Wikipedia entry for the term “file system” (as of Feb. 24, 2022) states as follows: “In computing, file system or filesystem . . . is a method and data structure that the operating system uses to control how data is stored and retrieved. Without a file system, data placed in a storage medium would be one large body of data with no way to tell where one piece of data stopped and the next began, or where any piece of data was located when it was time to retrieve it. By separating the data into pieces and giving each piece a name, the data is easily isolated and identified. Taking its name from the way a paper-based data management system is named, each group of data is called a “file.” The structure and logic rules used to manage the groups of data and their names is called a “file system.” There are many different kinds of file systems. Each one has different structure and logic, properties of speed, flexibility, security, size and more. Some file systems have been designed to be used for specific applications.”

### SUMMARY

According to an aspect of the present invention, there is a method, computer program product and/or computer system that performs the following operations (not necessarily in the following order): (i) receiving a first container, with the first container including a plurality of image layers for organizing a multiple layer file system; (ii) updating the plurality of image layers by inserting a new image layer, with the new image layer including a plurality of files to create a multiple layer file system; (iii) utilizing a storage driver to create a hard link between the new image layer and the plurality of image layers; and (iv) transferring, by the storage driver, the plurality of files from the new image layer to the plurality of image layers.

### BRIEF DESCRIPTION OF THE DRAWINGS

FIG. 1 depicts a cloud computing node used in a first embodiment of a system according to the present invention;

FIG. 2 depicts an embodiment of a cloud computing environment (also called the “first embodiment system”) according to the present invention;

FIG. 3 depicts abstraction model layers used in the first embodiment system;

FIG. 4 is a flowchart showing a first embodiment method performed, at least in part, by the first embodiment system;

FIG. 5 is a block diagram showing a machine logic (for example, software) portion of the first embodiment system;

FIG. 6 is a block diagram showing information that is helpful in understanding embodiments of the present invention;

FIG. 7 is a block diagram showing information that is helpful in understanding embodiments of the present invention;

FIG. 8 is a flow diagram showing information that is helpful in understanding ways to implement embodiments of the present invention;

FIG. 9 is a block diagram showing information that is helpful in understanding embodiments of the present invention;

FIG. 10 is a block diagram showing information that is helpful in understanding embodiments of the present invention; and

FIG. 11 is a block diagram showing information that is helpful in understanding embodiments of the present invention.

### DETAILED DESCRIPTION

Some embodiments of the present invention are directed towards creating a storage driver that is structured and configured to organize and operate a multiple layer file system on a cloud-based computing server, and more particularly to a containerized computing server. Additionally, the storage driver is used to improve the security of the containers and to define a static configuration of the multiple layer file system that is stored within the containers.

This Detailed Description section is divided into the following sub-sections: (i) The Hardware and Software Environment; (ii) Example Embodiment; (iii) Further Comments and/or Embodiments; and (iv) Definitions.

### I. The Hardware and Software Environment

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as Follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as Follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as Follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

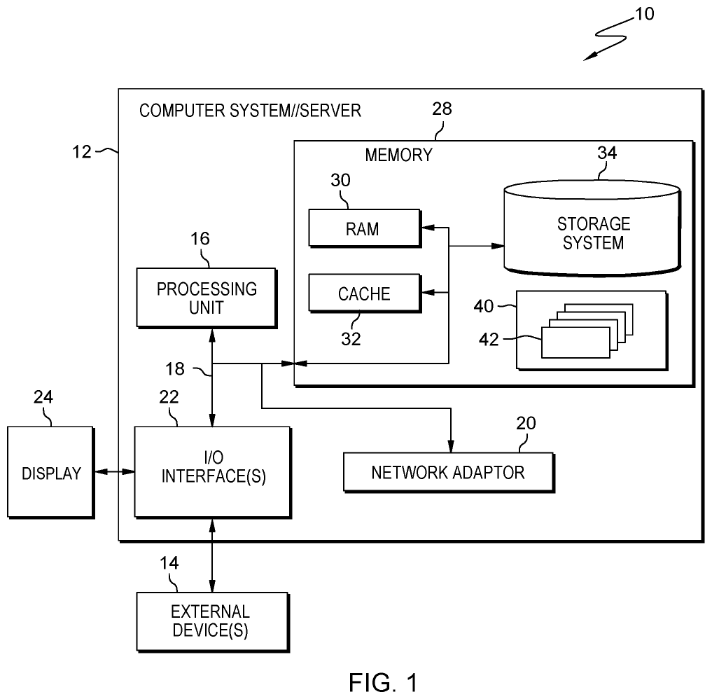

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples include, but are not limited to: microcode, device drivers, redundant processing units, external disk drive arrays, RAID systems, tape drives, and data archival storage systems, etc.

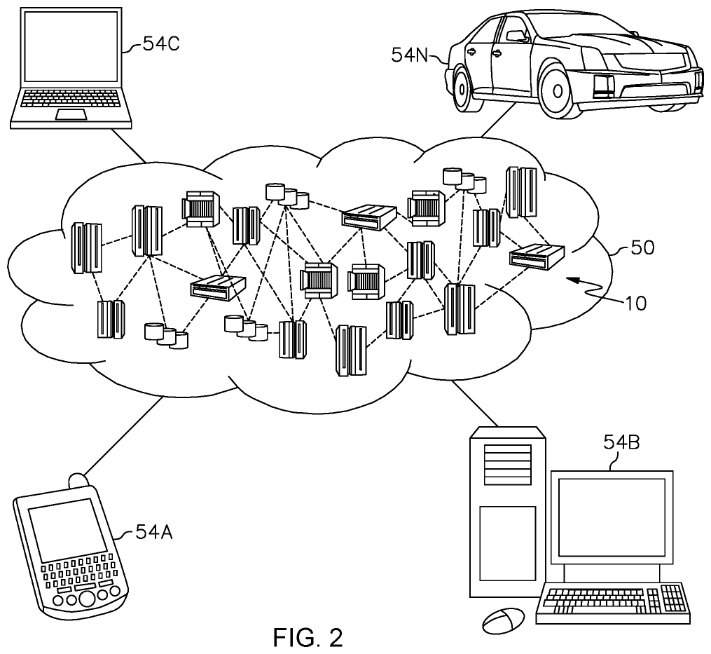

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

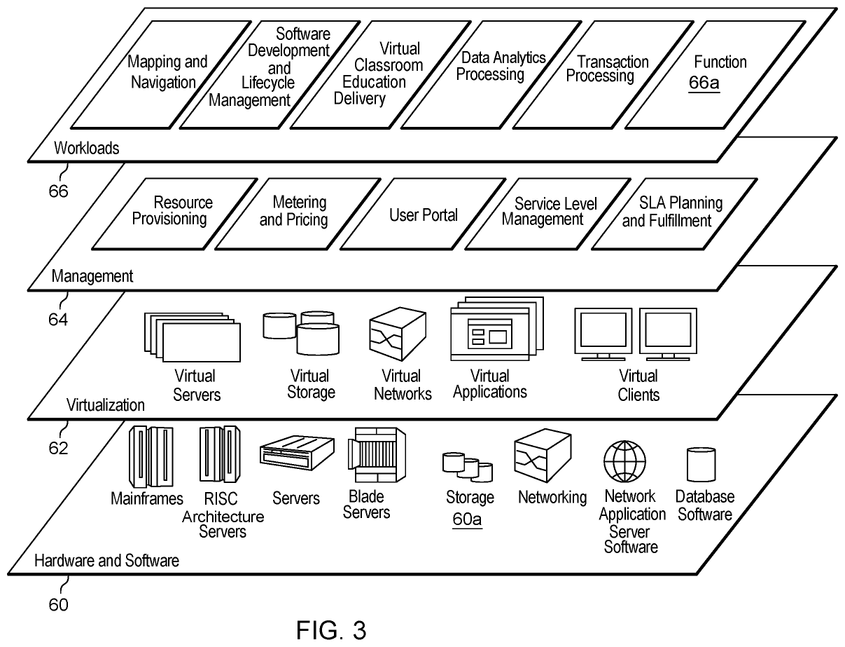

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include mainframes; RISC (Reduced Instruction Set Computer) architecture based servers; storage devices; networks and networking components. In some embodiments software components include network application server software.

Virtualization layer 62 provides an abstraction layer from which the following examples of virtual entities may be provided: virtual servers; virtual storage; virtual networks, including virtual private networks; virtual applications and operating systems; and virtual clients.

In one example, management layer 64 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provide pre-arrangement for, and procurement of, cloud computing resources for which a future requirement is anticipated in accordance with an SLA.

Workloads layer 66 provides examples of functionality for which the cloud computing environment may be utilized. Examples of workloads and functions which may be provided from this layer include: mapping and navigation; software development and lifecycle management; virtual classroom education delivery; data analytics processing; transaction processing; and functionality according to the present invention (see function block 66a) as will be discussed in detail, below, in the following sub-sections of this Detailed description section.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

### II. Example Embodiment

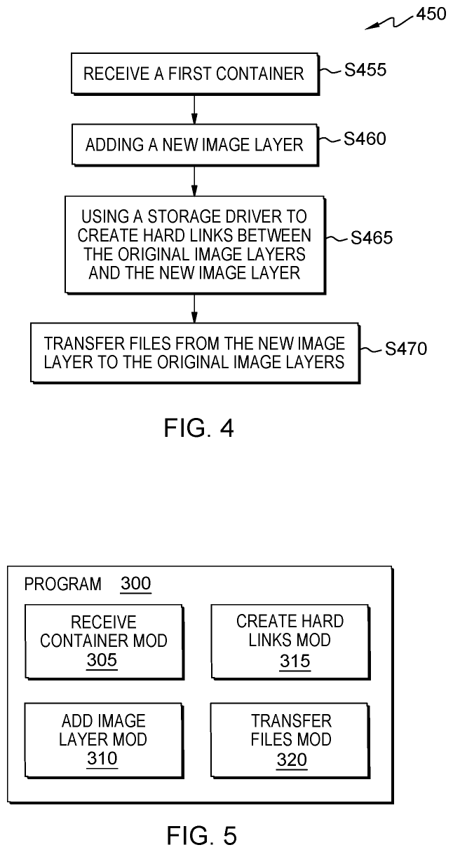

FIG. 4 shows flowchart 450 depicting a method according to the present invention. FIG. 5 shows program 300 for performing at least some of the method operations of flowchart 450. This method and associated software will now be discussed, over the course of the following paragraphs, with extensive reference to FIG. 4 (for the method operation blocks) and FIG. 5 (for the software blocks). One physical location where program 300 of FIG. 5 may be stored is in storage block 60a (see FIG. 3).

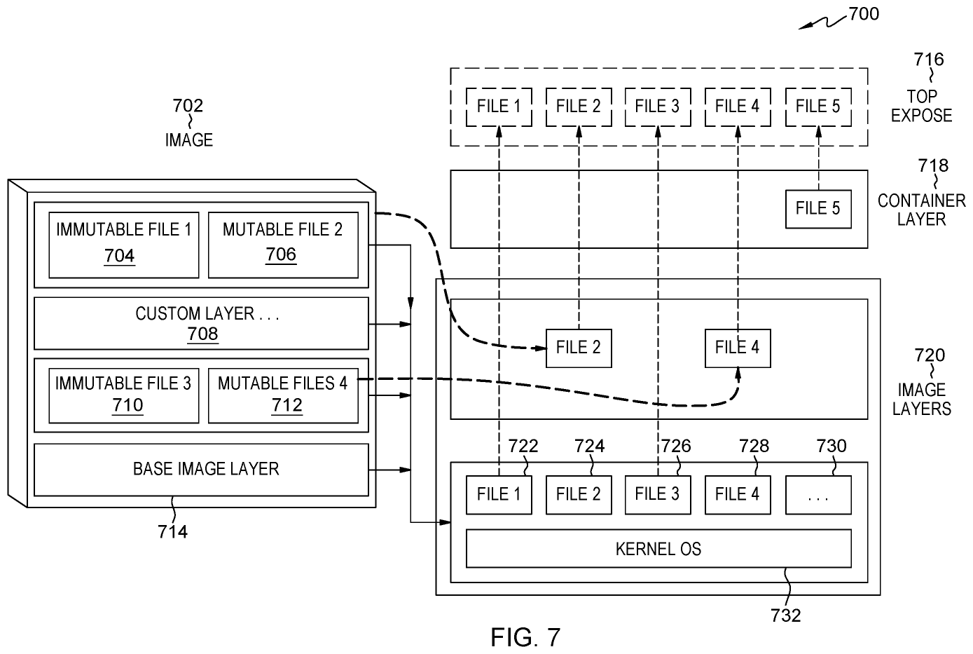

Processing begins at operation 5455, where receive container module (“mod”) 305 receives a first container. In some embodiments of the present invention, the first container includes a plurality of files that make a multiple layer file system. In some embodiments, the first container (such as container custom layer 708 shown in FIG. 7) is used to store different types of files in the multiple layer file system. This can include mutable files (such as mutable file 706 shown in FIG. 7) and immutable files (such as immutable file 704 shown in FIG. 7).

Processing proceeds to operation 5460, where add image layer mod 310 adds a new image layer to the first container. In some embodiments, the new image layer that is added to the first layer is a newly-added container layer (that is, the new image layer is a newly-added writable layer) that includes information indicating all relevant changes that are stored in the multiple layer file system.

Processing proceeds to operation 5465, where create hard links mod 315 creates hard links between the plurality of files stored in the new image layer and the plurality of files that existed in the original image layers found in the first container (discussed in connection with operation S455, above). In some embodiments of the present invention, hard links between the plurality of files stored in the new image layer and the plurality of files that existed in the original image layers are structured and configured in a manner that creates a set of file reference data that can be shared with multiple file layers in a space-efficient manner that minimizes the use of index nodes.

Processing finally proceeds to operation 5470, where transfer files mod 320 transfers the plurality of files from the new image layer to the original image layers by using the storage driver.

### III. Further Comments and/or Embodiments

Typically when creating a new container, a new writable layer (container layer) is created on top of the underlying layers. All of the changes are stored in this container layer (that is, the new writable layer), and multiple containers can share access to the same underlying image and yet have their own data state. Additionally, there are multiple storage drivers. The following two storage drivers can be used as an example: AUFS and OverlayFS.

AUFS is a union filesystem, which means that it layers multiple directories on a single Linux host and presents them as a single directory. The AUFS storage driver can typically introduce significant latencies into container write performance when these files exist below many image layers and the files themselves are large.

OverlayFS refers to the lower directory as “lowerdir” and the upper directory “upperdir.” The unified view is exposed through its own directory called “merged.” Hard links are then used as a space-efficient way to reference data shared with lower layers, that may cause an excessive use of index nodes.

Typically, the OverlayFS is faster than the same operation that is run with AUFS because of less layers that may incur larger latencies. However, the OverlayFS causes excessive index node (sometimes herein referred to as an “inode” or “inodes”) consumption. This is sometimes replaced by Overlay2, which also uses multiple layers.

Embodiments of the present invention provide: (i) a new storage driver (or sometimes referred to as a “Graph Driver”) for the multiple layer filesystem; (ii) a method to define the static configuration of multiple layer file system inside of container; (iii) a method to improve security of container basic on the static file system; and (iv) a system to update multiple layers file system dynamically basic on the layer information center.

Advantages to these include: (i) reducing latency into container write performance when these files exist with many image layers; (ii) reducing index node consumption of the system for the multiple layer file system(s); (iii) supports defining static file systems and updates dynamically; and (iv) improves container security to prevent the attack for a variety of user application(s).

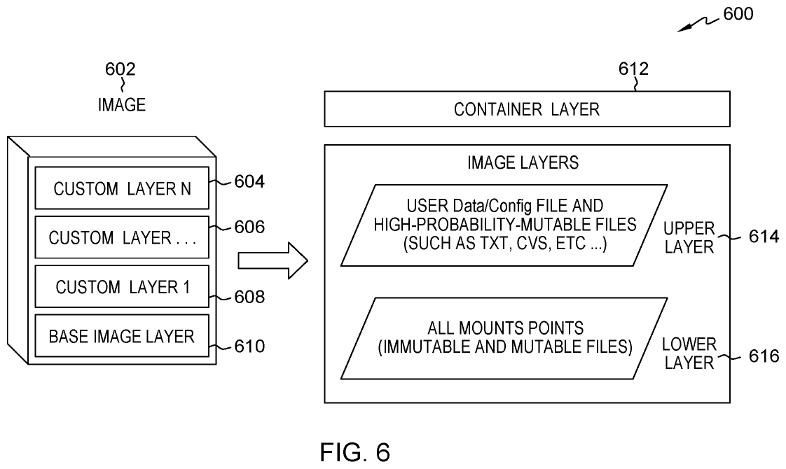

Some embodiments of the present invention provide for a new storage driver for a multiple layered file system (as shown in file layer diagram 600 of FIG. 6). File layer diagram 600 includes the following components: image 602 (which further includes base image layer 604, custom layer 606, custom layer 608, custom layer 610), container layer 612, upper image layer 614, and lower image layer 616.

In some embodiments, classified files in the image layer are split into two categories based on whether those files are writeable (such as user application data files and/or configuration files). These types of writeable files are placed in a single layer, and if these files need to be modified for any reason, the files can be found in the first layer (such as base image layer 610). A “copy-on-write” function can also be performed on these files, which includes copying the classified files to the container layer (such as container layer 612). These files can then be maintained in the container layer, which ultimately has the intended effect of reducing latencies because there is not a need to search for files in a layer-by-layer manner.

Some embodiments of the present invention generate one upper layer by a union mount of all the multiple layers of a given image and creates hard links for some writable files (such as application data/configuration files) and ignores immutable or low probability mutable files in the lower layer(s). This can avoid Mode consumption (only for hard links in the upper layer(s)). This is shown in block diagram 700 of FIG. 7).

Block diagram 700 includes: image 702, immutable file 704, mutable file 706, custom layer 708, immutable file 710, mutable file 712, base image layer 714, top expose layer 716, container layer 718, image layers 720, file 722, file 724, file 726, file 728, file 730, and kernel and operating system (OS) 732.

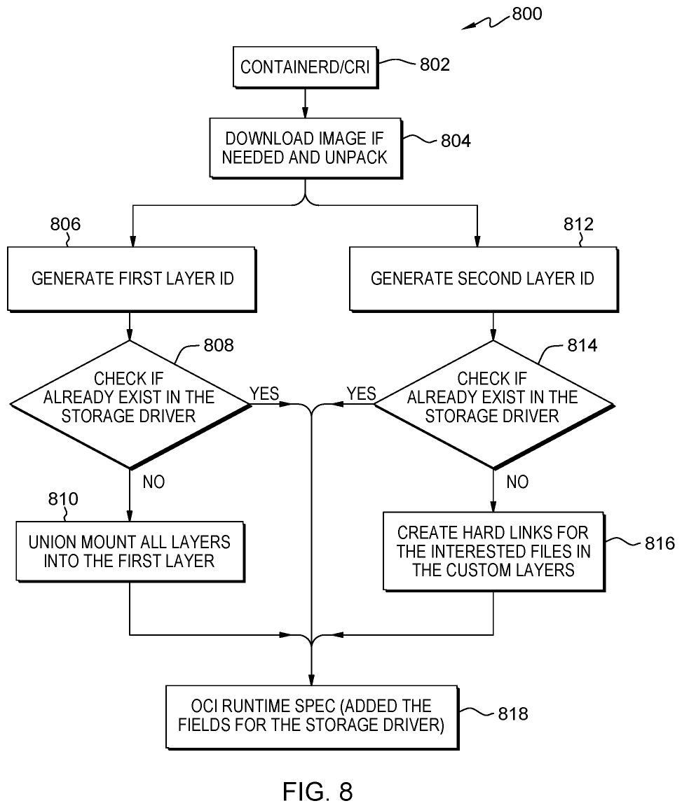

Flow diagram 800 of FIG. 8 shows a set of processes to generate the filesystem for the storage driver (discussed above). Flow diagram 800 can be condensed into the following general operations, including the following (and not necessarily in the following order): (i) receiving a containerd/CRI (operation 802); (ii) download image if needed and unpack (operation 804); (iii) generate the layer ID for the first layer and the second layer (use sha256) (operations 806 and 812, respectively); (iv) check to see whether the first layer ID already exists in the storage driver (operation 808); (v) check to see whether the second layer ID already exists in the storage driver (operation 814); (vi) if the layer ID (first layer ID or second layer ID) already exists, pass the ID to the OCI runtime (operation 818); (vii) if the first layer ID does not already exist in the storage driver, then union mount all layers into the first layer (operation 810); and (viii) if the second layer ID does not already exist in the storage driver, then create hard links for the interested files in the custom layers (operation 816).

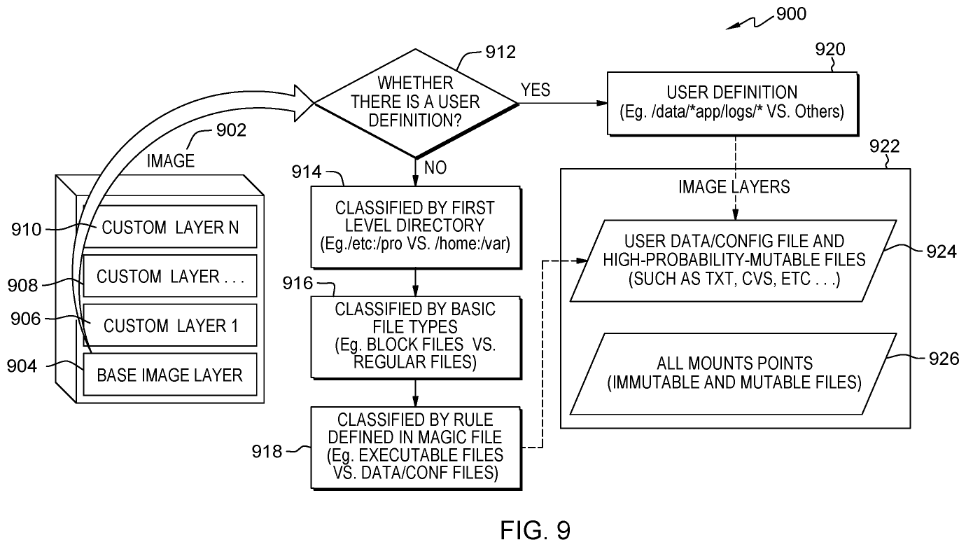

In some embodiments, files are classified by starting from the bottom custom layer and determining whether the user definition is supported. If the user defined the interested directory or files, then the container will only update the user defined directory or files to ensure security. Then, some embodiments check from the first level, reserve the high-probability modifying directory, and then exclude some block/character files. Lastly, some embodiments are classified by magic file (both for user magic file and system magic file). This is shown in block diagram 900 of FIG. 9 (specifically operation 918).

Block diagram 9 includes: image 902, base image layer 904, custom layer 906, custom layer 908, custom layer 910, operation 912, operation 914, operation 916, operation 918, operation 920, image layers 922, upper image layer 924, and lower image layer 926.

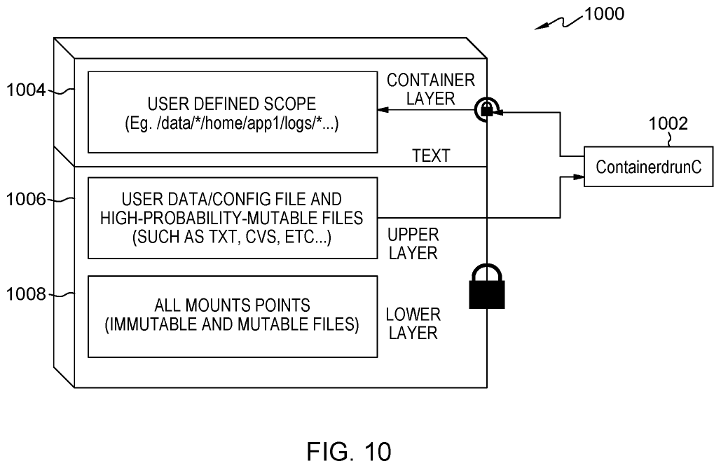

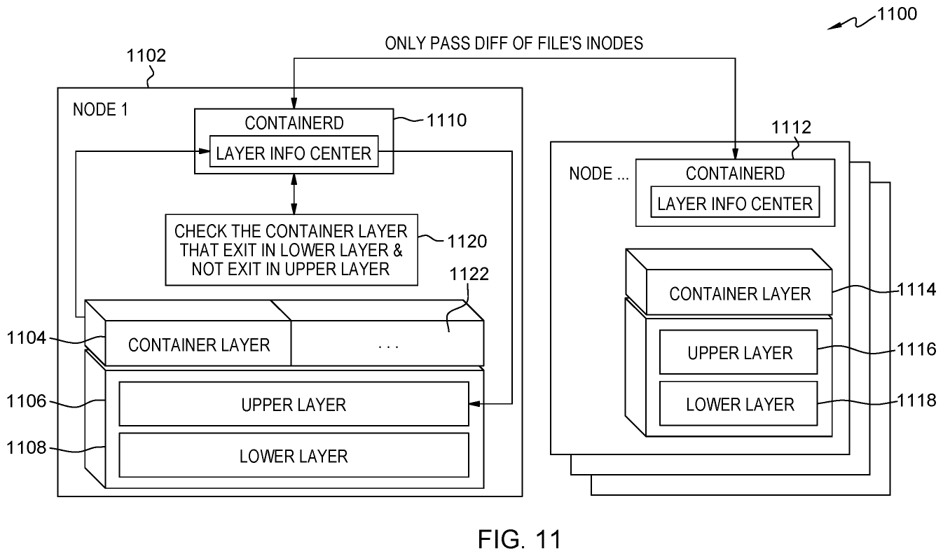

Some embodiments of the present invention are structured and configured to improve container security in a static file system. In the system, some embodiments provide some rules for the static layer definitions. For those, the case user will pay great attention to the security inside of the containers to prevent hacking or attacking. From there side to ensure security: Add/Modify/Delete. Before action on the files in the image, need to pass those rules as below chart showing. This is shown by block diagram 1000 of FIG. 10. Block diagram 1000 includes container 1002, container layer 1004, upper layer 1006, and lower layer 1008.

Some embodiments of the present invention are structured and configured to dynamically update the upper layer (as shown in block diagram 1100 of FIG. 11). Some embodiments introduce the module that is named “Layer info Center” (such as module 1110), the module will get report and find the file which is NOT in upper Layer but in Lower Layer, the Layer Info Center will update upper layer basic on the changes dynamically. Also can inform other layer info center on other nodes (only need to pass file's inodes differences). The communication can be basic on other infrastructure such as Kubernetes.

Block diagram 1100 includes: node 1102, container layer 1104, upper layer 1106, lower layer 1108, module 1110, module 1112, container layer 1114, upper layer 1116, lower layer 1118, check container layer mod 1120, and container layer 1122.

### IV. Definitions

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein are believed to potentially be new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

Including/include/includes: unless otherwise explicitly noted, means “including but not necessarily limited to.”

User/subscriber: includes, but is not necessarily limited to, the following: (i) a single individual human; (ii) an artificial intelligence entity with sufficient intelligence to act as a user or subscriber; and/or (iii) a group of related users or subscribers.

Data communication: any sort of data communication scheme now known or to be developed in the future, including wireless communication, wired communication and communication routes that have wireless and wired portions; data communication is not necessarily limited to: (i) direct data communication; (ii) indirect data communication; and/or (iii) data communication where the format, packetization status, medium, encryption status and/or protocol remains constant over the entire course of the data communication.

Receive/provide/send/input/output/report: unless otherwise explicitly specified, these words should not be taken to imply: (i) any particular degree of directness with respect to the relationship between their objects and subjects; and/or (ii) absence of intermediate components, actions and/or things interposed between their objects and subjects.

Without substantial human intervention: a process that occurs automatically (often by operation of machine logic, such as software) with little or no human input; some examples that involve “no substantial human intervention” include: (i) computer is performing complex processing and a human switches the computer to an alternative power supply due to an outage of grid power so that processing continues uninterrupted; (ii) computer is about to perform resource intensive processing, and human confirms that the resource-intensive processing should indeed be undertaken (in this case, the process of confirmation, considered in isolation, is with substantial human intervention, but the resource intensive processing does not include any substantial human intervention, notwithstanding the simple yes-no style confirmation required to be made by a human); and (iii) using machine logic, a computer has made a weighty decision (for example, a decision to ground all airplanes in anticipation of bad weather), but, before implementing the weighty decision the computer must obtain simple yes-no style confirmation from a human source.

Automatically: without any human intervention.

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

What is claimed is:

1. A computer-implemented method (CIM) comprising:
receiving a first container, with the first container including a plurality of image layers for organizing a multiple layer file system;
updating the plurality of image layers by inserting a new image layer, with the new image layer including a plurality of files to create a multiple layer file system;
utilizing a storage driver to create a hard link between the new image layer and the plurality of image layers; and
transferring, by the storage driver, the plurality of files from the new image layer to the plurality of image layers.

2. The CIM of claim 1 wherein the hard link between the new image layer and the plurality of image layers creates a set of file reference data, with the file reference data including information indicative of a relationship between file data stored in the new image layer and file data stored in the plurality of image layers.

3. The CIM of claim 1 wherein the storage driver is structured and configured to reduce the use of index notes.

4. The CIM of claim 1 wherein the storage driver is structured and configured to be space-efficient.

5. The CIM of claim 1 wherein the storage driver is structured and configured to improve write operation speeds for write-intensive applications.

6. The CIM of claim 1 wherein the plurality of files of the new image layer include mutable files and immutable files, with the mutable files and the immutable files being used to create the hard link to the plurality of image layers in the multiple layer file system.

7. A computer program product (CPP) comprising:
a machine readable storage device; and
computer code stored on the machine readable storage device, with the computer code including instructions and data for causing a processor(s) set to perform operations including the following:
receiving a first container, with the first container including a plurality of image layers for organizing a multiple layer file system,
updating the plurality of image layers by inserting a new image layer, with the new image layer including a plurality of files to create a multiple layer file system,
utilizing a storage driver to create a hard link between the new image layer and the plurality of image layers, and
transferring, by the storage driver, the plurality of files from the new image layer to the plurality of image layers.

8. The CPP of claim 7 wherein the hard link between the new image layer and the plurality of image layers creates a set of file reference data, with the file reference data including information indicative of a relationship between file data stored in the new image layer and file data stored in the plurality of image layers.

9. The CPP of claim 7 wherein the storage driver is structured and configured to reduce the use of index notes.

10. The CPP of claim 7 wherein the storage driver is structured and configured to be space-efficient.

11. The CPP of claim 7 wherein the storage driver is structured and configured to improve write operation speeds for write-intensive applications.

12. The CPP of claim 7 wherein the plurality of files of the new image layer include mutable files and immutable files, with the mutable files and the immutable files being used to create the hard link to the plurality of image layers in the multiple layer file system.

13. A computer system (CS) comprising:
a processor(s) set;
a machine readable storage device; and
computer code stored on the machine readable storage device, with the computer code including instructions and data for causing the processor(s) set to perform operations including the following:
receiving a first container, with the first container including a plurality of image layers for organizing a multiple layer file system,
updating the plurality of image layers by inserting a new image layer, with the new image layer including a plurality of files to create a multiple layer file system,
utilizing a storage driver to create a hard link between the new image layer and the plurality of image layers, and
transferring, by the storage driver, the plurality of files from the new image layer to the plurality of image layers.

14. The CS of claim 13 wherein the hard link between the new image layer and the plurality of image layers creates a set of file reference data, with the file reference data including information indicative of a relationship between file data stored in the new image layer and file data stored in the plurality of image layers.

15. The CS of claim 13 wherein the storage driver is structured and configured to reduce the use of index notes.

16. The CS of claim 13 wherein the storage driver is structured and configured to be space-efficient.

17. The CS of claim 13 wherein the storage driver is structured and configured to improve write operation speeds for write-intensive applications.

18. The CS of claim 13 wherein the plurality of files of the new image layer include mutable files and immutable files, with the mutable files and the immutable files being used to create the hard link to the plurality of image layers in the multiple layer file system.
